(19) United States
(12) Patent Application Publication
(10) Pub. No.: US 2021/0208110 A1
(43) Pub. Date: Jul. 8, 2021

(54) SCANNING APPARATUS AND SCANNING METHOD

(71) Applicant: 1CSI LTD, Aberdeen (GB)

(72) Inventors: Aleksandra Tomaszek, Aberdeen, Aberdeenshire (GB); Matthew Kennedy, Aberdeen, Aberdeenshire (GB)

(73) Assignee: 1CSI LTD, Aberdeen (GB)

(21) Appl. No.: 17/055,769

(22) PCT Filed: May 15, 2019
(86) PCT No.: PCT/GB2019/051325

§ 371 Date: Nov. 16, 2020

(30) Foreign Application Priority Data
May 17, 2018 (GB) 1808059.8

(51) Int. Cl. G01N 29/265; G01N 29/22; G01N 29/26

(52) U.S. Cl. CPC G01N 29/265; G01N 29/225; G01N 2291/2634; G01N 2291/106; G01N 29/262

(57) ABSTRACT

The present invention concerns a scanning apparatus (1) and method for scanning a sub-sea structure (2). The apparatus comprises a scanner array (3) and a guide for defining a direction of travel of the scanner array from a start position to a finish position. A drive means (10) is provided for moving the scanner array from the start position to the finish position and the array comprises a plurality of sensors arranged in a common plane that extends substantially orthogonally to the guide direction of travel.

The present invention relates to a scanning apparatus and a scanning method and more particularly, though not exclusively, to a scanning apparatus and a scanning method for use in scanning sub-sea sections of assets and structures within the oil and renewables (wind, wave, tide) industries.

In this regard, assets and structures such as offshore oil rig installations comprise multiple sections of metal framework and pipelines which require regular maintenance due to the harsh environment in which they are located. Such maintenance involves inspection of the metal assets and structures to check their integrity.

Current equipment for performing such inspection sub-sea has for example included the use of ROV deployed scanning devices that are, in use, fixedly clamped to, or around, the structure in order to carry out the scanning process. Two such known devices, Oceaneering's Neptune scanner and Sonomatic's Rov-It scanner, provide a 360 degree ultrasound examination of a pipeline section, and involve the clamping of a rigid metal framework around the pipeline section, within which the scanning apparatus can move to perform the scan.

A problem with such known scanner arrangements is the relatively slow pace of the actual scanning process, as well as the time involved in getting to and from the section to be scanned and clamping the required framework around the pipeline once there. Moreover, the process has little flexibility in that the framework has to fit around the structure to be scanned, meaning the framework has to be relatively specific for each diameter of pipeline being scanned. The section to be scanned must also be located where there is sufficient access for the framework to fit all around its circumference.

Moreover, positioning the bulky framework can be difficult where the structure being scanned has inclined sections and changes of directions, such as at junctions and corners. This inevitably restricts access to certain sections of pipeline.

An object of the present invention is to alleviate such problems.

According to a first aspect of the present invention there is provided scanning apparatus for scanning a sub-sea structure, the apparatus comprising:—a scanner array; a guide for defining a direction of travel of the scanner array from a start position to a finish position; a drive means for moving the scanner array from the start position to the finish position; wherein the array comprises a plurality of sensors arranged in a common plane that extends substantially orthogonally to the guide direction of travel. In this way, the apparatus can in a single pass accumulate information from a plurality of sensors thereby reducing the time required for the apparatus to be engaged with the sub-sea structure.

Preferably, the drive means is configured such that one pass of the scanner array from the start position to the finish position takes less than 30 seconds. Further, the drive means may be configured such that one pass of the scanner array from the start position to the finish position takes less than 20 seconds. In certain preferred embodiments, the drive means may be configured such that one pass of the scanner array from the start position to the finish position takes less than 10 seconds. In certain further preferred embodiments, the drive means may be configured such that one pass of the scanner array from the start position to the finish position takes less than 5 seconds. As such, the scanning apparatus can quickly and efficiently gather the required information and move on to a new scan site.

Conveniently, the guide comprises a track, the scanner array and track having complementary formations enabling sliding of the array relative to the track. The use of a track affords a reliable and stable path for controlling the movement of the scanner array.

Preferably, the guide is formed of deformable material allowing its longitudinal profile to be altered between different configurations. In this way, the guide can be adapted to the local environment as required.

The material characteristics of the guide may in certain embodiments be altered between a rigid state and a flexible adjustable state. When in a flexible state, the guide can be manipulated to conform to a profile to suit requirements.

Although alternative lengths may be used, the guide is preferably up to 40 cm long. This affords a suitable scan length to provide sufficient scan data.

Conveniently, the scanner array has a profile facing the structure to be scanned, where the scanner array profile is adjustable. In this regard, the profile may be adjusted to ensure a consistent spacing is provided between the face of the scanner array and the structure undergoing scanning.

Preferably, the scanner array comprises a plurality of scanner units, movably coupled with respect to one another. As such, the relative orientation is adjustable to suit requirements.

In preferred embodiments, the scanner units are hingeably connected, so that the profile facing the structure to be scanned can be adjusted as desired.

Preferably, the scanning apparatus further comprises one or more abutment members for abutting a structure at or adjacent a surface to be scanned and for maintaining the scanner array at a desired spacing from the surface to be scanned. In this way, the abutment members allow the apparatus to come into contact with the structure to be scanned, setting up a preferred spacing between the scanner array and the surface of the structure.

Conveniently, the one or more abutment members are pivotally hinged. In this manner the abutment members can conform to the surface of the structure to be scanned, to promote a reliable contact.

Although different scanning areas may be utilised, in one pass the scanner array preferably defines a scanning area substantially of 20 cm×30 cm. This is approximately the area of a standard A4 piece of paper and can provide sufficient data for analysis.

Preferably, the scanning apparatus further comprises a mount for removable connection to an ROV or an AUV. The mount allows the scanning apparatus to be readily detached and mounted to an ROV or AUV for ease of use.

The apparatus may in preferred embodiments comprise a plurality of interchangeable guides and scanner arrays. In this regard, the apparatus may be modular in form, so that for example different guides and scanner arrays can be interchanged, depending on particular requirements. Each guide and scanner array is preferably provided with a releasable mounting for facilitating attachment and detachments of the scanner array and guide.

According to a further aspect of the present invention there is provided a scanning method for scanning a pipeline section using scanning apparatus having a scanner array, a guide for defining a direction of movement of the scanner array from a start position to a finish position, and a drive means for moving the scanner array from the start position to the finish position; wherein the method comprises the steps of:—presenting the apparatus to the pipeline section by way of a drone, ROV or AUV; biasing the apparatus in position against the pipeline section using the drone, ROV or AUV, without fixedly coupling the apparatus to the pipeline section; carrying out a scan pass of the scanner array from the start position to the finish position; and using the drone, ROV or AUV to move the apparatus away from the pipeline section.

Preferably, the scan pass from the start position to the finish position takes less than 30 seconds. Further, the scan pass from the start position to the finish position may take less than 20 seconds. In certain preferred embodiments, the scan pass from the start position to the finish position may take less than 10 seconds. In certain further preferred embodiments, the scan pass from the start position to the finish position takes less than 5 seconds. As such, the scanning apparatus can quickly and efficiently gather the required information and move on to a new scan site.

Whilst the method may be used for use in various applications, it is conveniently applied to a subsea pipeline.

According to a yet further aspect of the present invention, there is provided scanning apparatus for scanning a sub-sea structure, the apparatus comprising:—a scanner array; a guide for defining a direction of travel of the scanner array from a start position to a finish position; and a drive means for moving the scanner array from the start position to the finish position; wherein the array comprises a plurality of phased array or adaptive sensors.

According a further aspect of the present invention there is provided scanning apparatus for scanning a sub-sea structure, the apparatus comprising:—a scanner array; a guide for defining a direction of travel of the scanner array from a start position to a finish position; and a drive means for moving the scanner array from the start position to the finish position; wherein the scanner array and guide are interchangeable with one or more alternative scanner arrays and guides of different configurations.

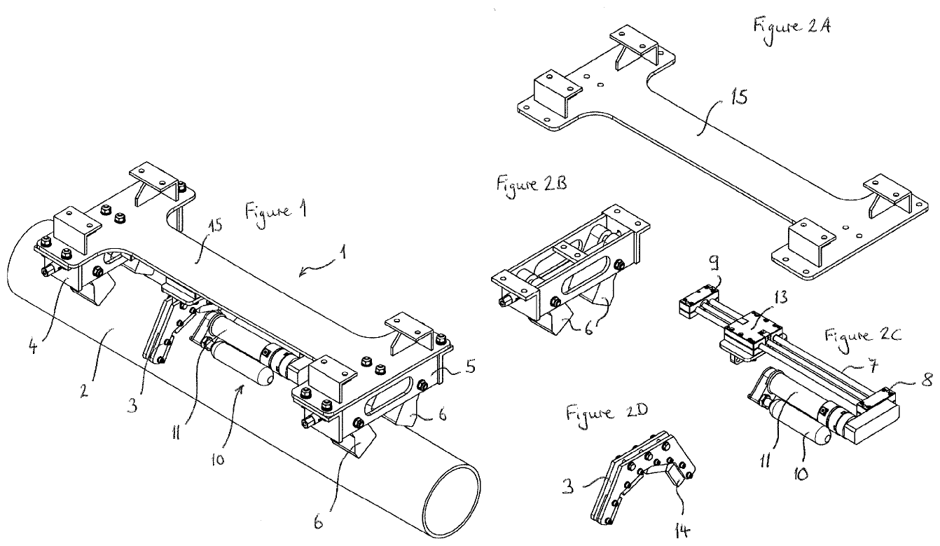

Certain preferred embodiments of the invention will now be described by way of example and with reference to FIGS. 1 to 7 of the attached drawings.

FIG. 1 shows a perspective view of apparatus according to the present invention;

FIGS. 2a, 2b, 2c and 2d show components of the apparatus of FIG. 1;

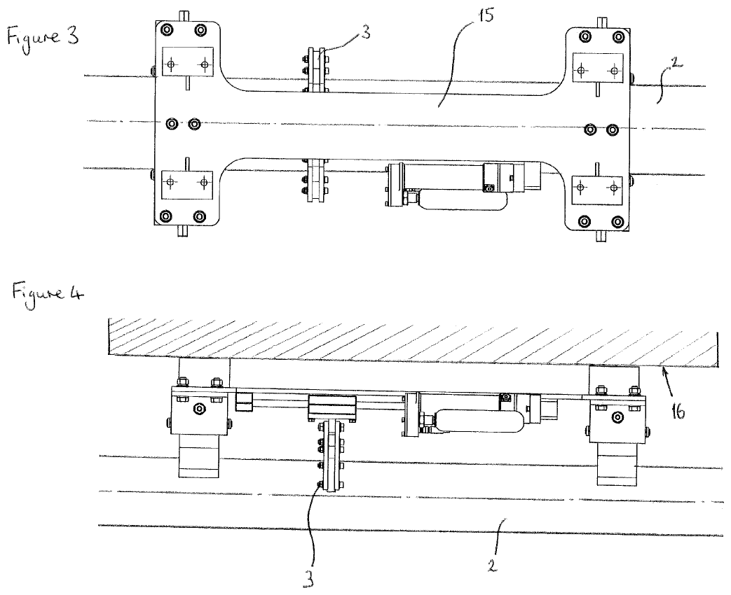

FIG. 3 shows a plan view from above of the apparatus of FIG. 1 when abutting a section of pipeline;

FIG. 4 shows a side view of the apparatus of FIG. 1 in position against a section of pipeline;

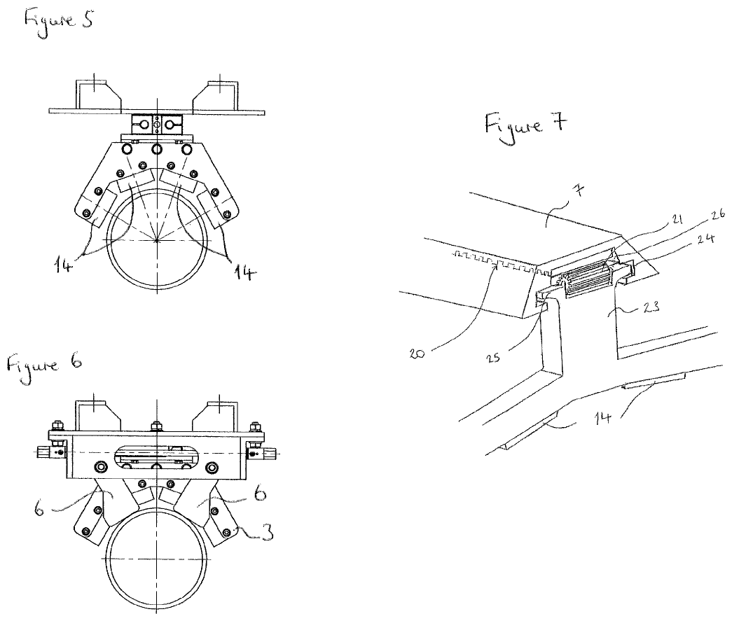

FIG. 5 shows an end view of the apparatus of FIG. 1 showing a scanner array;

FIG. 6 shows an end view of the apparatus of FIG. 1 showing abutment means contacting a section of pipeline; and

FIG. 7 shows a view of an alternative drive and guide means.

Referring to FIG. 1, this shows scanning apparatus 1 in position on a section of pipeline 2. The apparatus comprises a scanner array 3 mounted for linear movement between end assemblies 4 and 5.

The end assemblies 4, 5 have abutment members 6, which are arranged to abut the pipeline at or adjacent the section to be scanned. The abutment members enable the apparatus to “kiss” the pipeline without being fixedly attached thereto and may be pivotally mounted to allow them to adjust to enhance the contact with the pipeline surface. The abutment members hold the scanner array at a desired distance from the surface of the pipeline as it moves between the end assemblies.

As shown in FIGS. 2c and 4, the scanner array 3 is mounted for movement between the end assemblies 4, 5. The direction of movement is defined by a guide 7, which can take the form of guide bars on which the scanner array is slidably received. As shown in FIG. 7, an alternative drive and guide means may for example comprise a toothed track 20 configured within a guide channel 26 of the guide 7 which co-operates with a driven toothed cog or roller 21 provided on a support structure 23 of the scanner array 3. The track and cog may be formed of Oilon material. The support structure 23 may have arms 25 that slide in complementary grooves 24 formed in the guide channel.

In this connection, the guide defines start and finish positions 8, 9 for the scanner array. The start and finish positions may interchange for alternate scans so that the finish position for one scan pass may be the start position for the following scan pass. The track may be formed of a material that allows its profile to be adjusted. In particular, the longitudinal profile of the guide may be altered so that it adopts an angular or serpentine path for the scanner array to follow, should the scanning task have that requirement. One such deformable material may be an Oilon (oil filled nylon) based material. The guide/track may moreover have more than one path with junction points for enhanced flexibility of scanning. For example, where the guide is a track, it may take the form of a cross, with the scanner array mounting being divertable along different limbs of the cross.

Drive means 10 enables the scanner array 3 to be moved from a start position to a finish position so as to carry out a scan pass. The drive means may comprise an electric drive motor 11 coupled to a lead screw 12, whose rotation drives a scanner array mounting 13. The drive means may be electrically coupled to an ROV or AUV, for providing a source of power. Whilst an electric motor is described as the drive means, alternatives such as hydraulic or pneumatic may alternatively be employed.

The scanner array 3 is shown having four separate sensors in blocks 14 making up the array, although other numbers of sensor blocks may be used. The sensor array may be arranged in a custom profile for scanning a particular pipeline section as shown. As such, a plurality of different custom profiles may be provided for interchangeable coupling to the scanner array mounting 13.

Further, the sensors may be pivotally mounted with respect to one another so that the profile they present to the section being scanned may be varied as desired and to requirements.

The sensors may be of a phased array or adaptive configuration.

FIG. 1, 2A and 4 show mounting plate 15 onto which the other components of the apparatus are mounted. This may, for example, be formed of polymer or Nylon based materials.

FIG. 4 moreover shows the underside surface of an ROV/AUV to which the mounting plate 15 is coupled.

In this connection, in use of the apparatus 1, it is coupled to an ROV/AUV and navigated by the ROV/AUV close to the pipeline section. The ROV/AUV is then deployed bias the scanning apparatus into contact with the pipeline and maintain its position there as the scanning operation is carried out.

Once at the correct position, the drive means is activated to cause the scanner array to move from a start position to a finish position. In so doing an area of around 20 cm×30 cm is scanned. A single pass is performed quickly, taking less than 30 seconds. The single pass may in further embodiments take less than 20 seconds, less than 10 seconds or less than 5 seconds.

Once scanning is complete the ROV/AUV can move away for scanning a new section.

1. Scanning apparatus for scanning a sub-sea structure, the apparatus comprising:
a scanner array;
a guide for defining a direction of travel of the scanner array from a start position to a finish position; and
a drive means for moving the scanner array from the start position to the finish position;
wherein the array comprises a plurality of sensors arranged in a common plane that extends substantially orthogonally to the guide direction of travel.

2. Scanning apparatus according to claim 1, wherein the drive means is configured such that one pass of the scanner array from the start position to the finish position takes less than 30 seconds.

3. Scanning apparatus according to claim 1, wherein the guide comprises a track, the scanner array and track having complementary formations enabling sliding of the array relative to the track.

4. Scanning apparatus according to claim 1, wherein the guide is formed of deformable material allowing its longitudinal profile to be altered between different configurations.

5. Scanning apparatus according to claim 1, wherein the material characteristics of the guide can be altered between a rigid state and a flexible adjustable state.

6. Scanning apparatus according to claim 1, wherein the guide is up to 40 cm long.

7. Scanning apparatus according to claim 1, wherein the scanner array has a profile facing the structure to be scanned, where the scanner array profile is adjustable.

8. Scanning apparatus according to claim 1, wherein the scanner array comprises a plurality of scanner units, movably coupled with respect to one another.

9. Scanning apparatus according to claim 8, wherein the scanner units are hingeably connected.

10. Scanning apparatus according to claim 1, further comprising one or more abutment members for abutting a structure at or adjacent a surface to be scanned and for maintaining the scanner array at a desired spacing from the surface to be scanned.

11. Scanning apparatus according to claim 10, wherein the one or more abutment members are pivotally hinged.

12. Scanning apparatus according to claim 1, wherein in one pass, the scanner array defines a scanning area substantially of 20 cm×30 cm.

13. Scanning apparatus according to claim 1, further comprises a mount for removable connection to an ROV or an AUV.

14. Scanning apparatus according to claim 1, comprising a plurality of interchangeable guides and scanner arrays.

15. Scanning apparatus according to claim 1, wherein the or each guide and scanner array is provided with a releasable mounting for facilitating attachment and detachment of the scanner array and guide.

16. A scanning method for scanning a pipeline section using scanning apparatus having a scanner array, a guide for defining a direction of movement of the scanner array from a start position to a finish position, and a drive means for moving the scanner array from the start position to the finish position; wherein the method comprises the steps of:
a. presenting the apparatus to the pipeline section by way of an ROV, AUV or drone;
b. biasing the apparatus in position against the pipeline section using the ROV, AUV or drone, without fixedly coupling the apparatus to the pipeline section;
c. carrying out a scan pass of the scanner array from the start position to the finish position; and
d. using the ROV, AUV or drone to move the apparatus away from the pipeline section.

17. The scanning method according to claim 16, wherein the scan pass from the start position to the finish position takes less than 30 seconds.

18. The scanning method according to claim 16, wherein method is applied to a subsea pipeline.

19. Scanning apparatus for scanning a sub-sea structure, the apparatus comprising:
scanner array;
a guide for defining a direction of travel of the scanner array from a start position to a finish position; and
a drive means for moving the scanner array from the start position to the finish position;
wherein the array comprises a plurality of phased array or adaptive sensors.

20. Scanning apparatus for scanning a sub-sea structure, the apparatus comprising:
a scanner array;
a guide for defining a direction of travel of the scanner array from a start position to a finish position; and
a drive means for moving the scanner array from the start position to the finish position; wherein the scanner array and guide are interchangeable with one or more alternative scanner arrays and guides of different configurations.
